(19) United States
(12) Patent Application Publication
(10) Pub. No.: US 2025/0297091 A1
(43) Pub. Date: Sep. 25, 2025

(54) PHOTOPOLYMER COMPOSITION, PHOTOPOLYMER FILM, HOLOGRAPHIC RECORDING MEDIUM, OPTICAL ELEMENT AND HOLOGRAPHIC RECORDING METHOD

(71) Applicant: LG CHEM, LTD., Seoul (KR)

(72) Inventors: Chulsuk HONG, Daejeon (KR); Hanna LEE, Daejeon (KR); Min Soo KIM, Daejeon (KR); Yeonhui YI, Daejeon (KR); Soonhwa JUNG, Daejeon (KR); Inkyu LEE, Daejeon (KR)

(73) Assignee: LG CHEM, LTD., Seoul (KR)

(21) Appl. No.: 18/861,477

(22) PCT Filed: Oct. 20, 2023
(86) PCT No.: PCT/KR2023/016312

§ 371 Date: Oct. 29, 2024

(30) Foreign Application Priority Data
Nov. 14, 2022 (KR) 10-2022-0151484

(51) Int. Cl. C08L 51/00; C08K 5/06; G11B 7/24044

(52) U.S. Cl. CPC C08L 51/003; C08K 5/06; G11B 7/24044; C08L 2203/16

(57) ABSTRACT

The present invention relates to a photopolymer composition for hologram formation and a photopolymer film using the same, a holographic recording medium, a holographic recording method and an optical element. The photopolymer composition includes a monofunctional monomer having a low molecular weight, and thus can provide a photopolymer film that realizes diffraction efficiency and higher refractive index modulation value even at a thin thickness, has excellent recording efficiency, exhibits excellent durability in high temperature and high humidity environments, and is excellent in haze, peel adhesive force and adhesion characteristics, and to a holographic recording medium and an optical element including the same.

### CROSS-REFERENCE TO RELATED APPLICATION(S)

This application is a 35 U.S.C. § 371 National Phase Entry Application from PCT/KR2023/016312, filed on Oct. 20, 2023, which claims the benefit of Korean Patent Application No. 10-2022-0151484 filed on Nov. 14, 2022 with the Korean Intellectual Property Office, the disclosures of which are incorporated herein by reference in their entirety. The present invention relates to a photopolymer composition for hologram formation, a photopolymer film, a holographic recording medium, an optical element and a holographic recording method.

### TECHNICAL FIELD

### Background

Holographic recording medium records information by changing a refractive index in the holographic recording layer in the medium through an exposure process, reads the variation of refractive index in the medium thus recorded, and reproduces the information.

In this regard, a photopolymer composition can be used for preparing a hologram. The photopolymer can easily store light interference pattern as a hologram by photopolymerization of a photoreactive monomer. Therefore, the photopolymer can be used in various fields such as, for example, smart devices such as mobile devices, wearable display parts, vehicle articles (e.g., head up display), holographic fingerprint recognition system, optical lenses, mirrors, deflecting mirrors, filters, diffusing screens, diffraction elements, light guides, waveguides, holographic optical elements having projection screen and/or mask functions, medium of optical memory system and light diffusion plate, optical wavelength multiplexers, reflection type, transmission type color filters, and the like.

Specifically, a photopolymer composition for hologram production includes a polymer matrix, a photoreactive monomer, and a photoinitiator system, and the photopolymer film prepared from such a composition is irradiated with laser interference light to induce photopolymerization of local monomers.

A refractive index modulation is generated through this local photopolymerization process, and a diffraction grating is generated by such a refractive index modulation. The refractive index modulation value (Δn) is influenced by the thickness and the diffraction efficiency (DE) of the photopolymer film, and the angular selectivity increases as the thickness decreases.

Recently, development of materials capable of maintaining a stable hologram with a high diffraction efficiency has been demanded, and also various attempts have been made to produce a photopolymer film having high diffraction efficiency and high refractive index modulation values as well as a thin thickness.

On the other hand, when a holographic recording medium is used as an optical element in applications such as mobile devices or vehicle articles (e.g., head-up display), it is placed in a high temperature/high humidity environment. In this case, the diffraction grating of the holographic recording medium may be deformed due to the external environment, which causes a decrease in clarity or visibility.

In other words, the high heat resistance and moist heat resistance reliability of the photopolymer film included in the holographic optical element (HOE) play an important role in preventing changes in recording wavelength from high temperature or high humidity environments of film-applied products. In addition, the haze characteristics of the photopolymer film after recording increase the clarity and visibility when viewed from the outside through the film when the film is commercialized. Further, peel adhesive force and adhesion can also prevent deformation of the outside shape of the photopolymer film due to the external environment of the photopolymer film.

However, currently used holographic recording media do not exhibit heat resistance and moist heat resistance reliability that can prevent deformation due to high temperature/high humidity environments.

Therefore, there is a need to develop a photopolymer film that can minimize deformation of the outside shape of the film even in various surrounding usage environments and is excellent in both recording efficiency and reliability, and a holographic recording medium comprising the same.

### BRIEF SUMMARY

### Technical Problem

It is an object of the present invention to provide a photopolymer composition for hologram formation that can adjust the content ratio of monofunctional monomers having a low molecular weight among recording monomers, thereby realizing a higher refractive index modulation value even in a thin thickness range, and at the same time, can efficiently provide a photopolymer layer having high recording efficiency (diffraction efficiency), excellent heat resistance and moist heat resistance reliability, haze, peel adhesive force and adhesion characteristics.

It is another object of the present invention to provide a photopolymer film that includes a photopolymer layer comprising the photopolymer composition, that has high recording efficiency (diffraction efficiency) and is excellent in heat resistance and moist heat resistance reliability, haze, peel adhesive force and adhesion characteristics, and thus can prevent deformation of the outside shape due to the external environment, and a holographic recording medium comprising the same.

It is yet another object of the present invention to provide a recording method of a holographic recording medium.

It is a further object of the present invention to provide an optical element comprising the holographic recording medium.

### Technical Solution

Provided herein is a photopolymer composition for forming a holographic recording medium, comprising: a polymer matrix or a precursor thereof formed by crosslinking a siloxane-based polymer containing a silane functional group and a (meth)acrylic-based polyol; a photoreactive monomer including a monofunctional monomer and a polyfunctional monomer; and a photoinitiator,
wherein the monofunctional monomer is contained in an amount of 42 to 55 parts by weight based on 100 parts by weight of the photoreactive monomer.

Also provided herein is a photopolymer film comprising a substrate film; and a coating layer including the photopolymer composition.

Further provided herein is a holographic recording medium comprising the photopolymer film.

Further provided herein is an optical element comprising the holographic recording medium,

Further provided herein is a holographic recording method comprising selectively polymerizing a monofunctional monomer and a polyfunctional monomer contained in the photopolymer composition using a coherent laser.

### DETAILED DESCRIPTION

Hereinafter, a photopolymer composition, a photopolymer film, a holographic recording medium, a preparation method thereof, an optical element comprising the same, and the like according to specific embodiments of the present invention will be described.

As used herein, the (meth)acrylate refers to either methacrylate or acrylate.

As used herein, the (co) polymer refers to either a homopolymer or a copolymer (including a random copolymer, a block copolymer, and a graft copolymer).

The term “hologram” as used herein refers to a recording medium in which optical information is recorded in an entire visible range and a near ultraviolet range (e.g., 300 to 800 nm) through an exposure process, and examples thereof include all of visual holograms such as in-line (Gabor) holograms, off-axis holograms, full-aperture transfer holograms, white light transmission holograms (“rainbow holograms”), Denisyuk holograms, off-axis reflection holograms, edge-lit holograms or holographic stereograms.

As used herein, the alkyl group may be straight-chain or branched-chain, and the carbon number thereof is not particularly limited, but is preferably 1 to 40. According to one embodiment, the carbon number of the alkyl group is 1 to 20. According to another embodiment, the carbon number of the alkyl group is 1 to 10. According to another embodiment, the carbon number of the alkyl group is 1 to 6. Specific examples of the alkyl group include methyl, ethyl, propyl, n-propyl, isopropyl, butyl, n-butyl, isobutyl, tert-butyl, sec-butyl, 1-methyl-butyl, 1-ethyl-butyl, pentyl, n-pentyl, isopentyl, neopentyl, tert-pentyl, hexyl, n-hexyl, 1-methylpentyl, 2-methylpentyl, 4-methyl-2-pentyl, 3,3-dimethylbutyl, 2-ethylbutyl, heptyl, n-heptyl, 1-methylhexyl, cyclopentylmethyl, cyclohexylmethyl, octyl, n-octyl, tert-octyl, 1-methylheptyl, 2-ethylhexyl, 2-propylpentyl, n-nonyl, 2,2-dimethylheptyl, 1-ethyl-propyl, 1,1-dimethyl-propyl, isohexyl, 2-methylpentyl, 4-methylhexyl, 5-methylhexyl, and the like, but are not limited thereto.

As used herein, the alkylene group is a bivalent functional group derived from alkane, and may be, for example, straight-chain, branched-chain or cyclic methylene group, ethylene group, propylene group, isobutylene group, sec-butylene group, tert-butylene group, pentylene group, hexylene group, and the like.

As used herein, the term “substituted or unsubstituted” means being unsubstituted or substituted with one or more substituent groups selected from the group consisting of deuterium; a halogen group; a cyano group; a nitro group; a hydroxy group; a carbonyl group; an ester group; an imide group; an amino group; a primary amino group; a carboxyl group; a sulfonic acid group; a sulfonamide group; a phosphine oxide group; an alkoxy group; an aryloxy group; an alkylthioxy group; an arylthioxy group; an alkylsulfoxy group; an arylsulfoxy group; a silyl group; a boron group; an alkyl group; a haloalkyl group; a cycloalkyl group; an alkenyl group; an aryl group; an aralkyl group; an aralkenyl group; an alkylaryl group; an alkoxysilylalkyl group; an arylphosphine group; or a heterocyclic group containing at least one of N, O and S atoms, or being unsubstituted or substituted with a substituent group to which two or more substituent groups of the above-exemplified substituent groups are linked. For example, “a substituent group in which two or more substituents are linked” may be a biphenylyl group. Namely, a biphenylyl group may be an aryl group, or it may be interpreted as a substituent group in which two phenyl groups are linked. In one example, “a substituent in which two or more substituents are linked” may be a biphenyl group. Namely, a biphenylyl group may be an aryl group, or it may also be interpreted as a substituent in which two phenyl groups are linked. Preferably, a halogen group may be used as the substituent, and examples of the halogen group include a fluoro group.

The term “hologram” as used herein refers to a recording medium in which optical information is recorded in an entire visible range and an ultraviolet range (e.g., 300 to 1,200 nm) through an exposure process, unless specifically stated otherwise. For example, the hologram herein may include all of visual holograms such as in-line (Gabor) holograms, off-axis holograms, full-aperture transfer holograms, white light transmission holograms (“rainbow holograms”), Denisyuk holograms, off-axis reflection holograms, edge-lit holograms or holographic stereograms.

In this specification, in relation to environmental conditions, etc. under which a holographic recording medium or a device including the same is placed, “high temperature” may mean a temperature of 60° C. or more. For example, the high temperature may mean a temperature of 65° C. or more, 70° C. or more, 75° C. or more, 80° C. or more, 85° C. or more, or 90° C. or more, and the upper limit thereof is not particularly limited, but may be, for example, 110° C. or less, 105° C. or less, 100° C. or less, 95° C. or less, 90° C. or less, 85° C. or less, or 80° C. or less. When temperature affects the characteristics of a material, object, or component, unless temperature is specifically mentioned otherwise, the temperature condition under which the characteristic is measured or explained may mean a room temperature (e.g., a temperature in the range of about 15 to 30° C. which is a temperature without heating or cooling).

Further, in this specification, with regard to environmental conditions, etc. under which a holographic recording medium or a device including the same is placed, “high humidity” may mean a relative humidity of 80% or more. For example, high humidity conditions may mean conditions that satisfy a relative humidity of 85% or more, 90% or more, or 95% or more. When humidity affects the characteristics of a material, object, or component, unless specifically stated otherwise, the humidity conditions under which the characteristics are measured or explained is a case where the relative humidity is lower than the high humidity condition. For example, it may be a relative humidity condition in the range of 15% or more and less than 80%, and specifically, it refers to relative humidity conditions where the lower limit is 20% or more, 25% or more, 30% or more, 35% or more, and 40% or more, and the upper limit thereof is 75% or less, 70% or less, 65% or less, or 60% or less.

Further, in this specification, high temperature/high humidity conditions may mean environmental conditions that satisfy at least one of the high temperature conditions and high humidity conditions described above.

Further, in this specification, the weight average molecular weight (Mw) and the number average molecular weight (Mn) refers to the molecular weight converted in terms of polystyrene (unit: Da (Dalton)) measured by gel permeation chromatography (GPC). In the process of determining the weight average molecular weight in terms of polystyrene measured by the GPC method, a detector such as a commonly known analysis apparatus and differential refractive index detector, and an analytical column can be used, and commonly applied conditions for temperature, solvent, and flow rate can be used. Specific examples of the measurement conditions may include a temperature of 30° C., chloroform solvent and a flow rate of 1 mL/min. In specific examples of the measurement conditions, a Waters PL-GPC220 instrument was used with a PLgel MIX-B column (length of 300 mm) from Polymer Laboratories, the evaluation temperature was 160° C., 1,2,4-trichlorobenzene was used as a solvent, and the flow rate was 1 mL/min. The sample was prepared at a concentration of 10 mg/10 mL, and then supplied in an amount of 200 μL. The values of Mw and Mn can be respectively determined using the calibration curve generated with polystyrene standards. Nine types of the polystyrene standards with respective molecular weights of 2,000/10,000/30,000/70,000/200,000/700,000/2,000,000/4,000,000/10,000,000 were used.

According to one embodiment of the invention, there is provided a photopolymer composition for forming a holographic recording medium, comprising: a polymer matrix or a precursor thereof formed by crosslinking a siloxane-based polymer containing a silane functional group and a (meth)acrylic-based polyol; a photoreactive monomer including a monofunctional monomer and a polyfunctional monomer; and a photoinitiator, wherein the monofunctional monomer is contained in an amount of 42 to 55 parts by weight based on 100 parts by weight of the photoreactive monomer.

The present inventors have found that a monofunctional acrylate compound having a low molecular weight along with a photoreactive monomer is used as a recording material for a holographic recording medium to adjust the usage ratio thereof, whereby the recording efficiency of the photopolymer layer of the holographic recording medium is better than a conventional one, and heat resistance and moist heat resistance reliability, haze, peel adhesive force and adhesion characteristics are improved, thereby preventing deformation of the outside shape of a photopolymer film due to high temperature/high humidity external environment, and completed the present invention.

That is, the present invention provides a photopolymer composition in which the ratio of the monofunctional monomer in the recording monomer is adjusted to a specific range, and thereby can realize high heat resistance and moist heat resistance reliability of the photopolymer film included in the holographic optical element (HOE). Therefore, the present invention can prevent a change in recording wavelength even in high temperature/high humidity environments of film-applied products using the photopolymer composition, and thus exhibit excellent haze characteristics, peel adhesive force and adhesion characteristics. Thus, according to the present invention, a holographic recording medium having excellent clarity and visibility and an optical element comprising the same having excellent performance can be provided.

At this time, the peel adhesive force refers to the degree of peel adhesion between the photopolymer film and OCA (Optical Clear Adhesive) film, and the adhesion refers to the degree of adhesion between the photopolymer layer and the base material using a photopolymer composition during the production of the photopolymer film.

Below, a photopolymer composition, a photopolymer film formed from the photopolymer composition, a holographic recording medium and a holographic recording method, and an optical element comprising the holographic recording medium according to an embodiment of the present invention will be described in more detail.

The photopolymer composition of one embodiment includes a polymer matrix or a precursor thereof that serves as a support for the photopolymer layer formed therefrom.

The polymer matrix is formed by crosslinking a siloxane-based polymer containing a silane functional group (Si—H) and a (meth)acrylic-based polyol. Specifically, the polymer matrix is formed by crosslinking (meth)acrylic-based polyol with a siloxane-based polymer containing a silane functional group. More specifically, the hydroxy group of the (meth)acrylic-based polyol can form a crosslink with the silane functional group of the siloxane-based polymer through a hydrosilylation reaction. The hydrosilylation reaction can proceed rapidly under a Pt-based catalyst even at room temperature (e.g., a temperature in the range of about 15 to 30° C. which is a temperature without heating or cooling). Therefore, the photopolymer composition according to one embodiment of the invention employs a polymer matrix that can be quickly crosslinked even at room temperature as a support, thereby being able to improve the preparation efficiency and productivity of the holographic recording medium.

The polymer matrix can enhance the mobility of components (e.g., photoreactive monomer or plasticizer, etc.) contained in the photopolymer layer due to the flexible main chain of the siloxane-based polymer. In addition, siloxane bonding having excellent heat resistance and moist heat resistance characteristics can facilitate ensuring reliability of the photopolymer layer in which optical information is recorded, and of the holographic recording medium including the same.

The polymer matrix may have a relatively low refractive index, which can thus serve to enhance the refractive index modulation of the photopolymer film. For example, the upper limit of the refractive index of the polymer matrix may be 1.53 or less, 1.52 or less, 1.51 or less, 1.50 or less, or 1.49 or less. And, the lower limit of the refractive index of the polymer matrix may be, for example, 1.41 or more, 1.42 or more, 1.43 or more, 1.44 or more, 1.45 or more, or 1.46 or more. As used herein, “refractive index” may be a value measured with an Abbe refractometer at 25° C.

The photopolymer layer may include the polymer matrix in crosslinked form as described above, or may include a precursor thereof. When the photopolymer composition includes a precursor of the polymer matrix, it may include a siloxane-based polymer, a (meth)acrylic-based polyol, and a Pt-based catalyst.

As a specific example, the siloxane-based polymer may include a repeating unit represented by the following Chemical Formula 1 and a terminal end group represented by the following Chemical Formula 2.

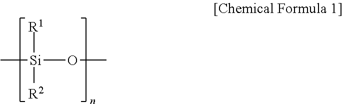

wherein, in Chemical Formula 1,
a plurality of R¹ and R² are the same or different from each other, and are each independently hydrogen, halogen, or an alkyl group having 1 to 10 carbon atoms, and
n is an integer of 1 to 10,000,

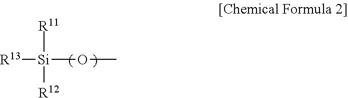

wherein, in Chemical Formula 2,
a plurality of R¹¹ and R¹³ are the same or different from each other, and are each independently hydrogen, halogen, or an alkyl group having 1 to 10 carbon atoms, and
at least one of R¹, R² and R¹¹ to R¹³ of at least one repeating unit among the repeating units represented by Chemical Formula 1 and any one terminal end group among the terminal end groups represented by Chemical Formula 2 is hydrogen.

In Chemical Formula 2, —(O)— means either bonding through oxygen (O) or directly bonding without oxygen (O) when Si of the terminal end group represented by Chemical Formula 2 is bonded to the repeating unit represented by Chemical Formula 1.

As used herein, “alkyl group” may be a straight-chain, branched-chain, or cyclic alkyl group. By way of non-limiting example, “alkyl group” as used herein may be methyl, ethyl, propyl (e.g. n-propyl, isopropyl, etc.), butyl (e.g., n-butyl, isobutyl, tert-butyl, sec-butyl, cyclobutyl, etc.), pentyl (e.g., n-pentyl, isopentyl, neopentyl, tert-pentyl, 1,1-dimethyl-propyl, 1-ethyl-propyl, 1-methyl-butyl, cyclopentyl, etc.), hexyl (e.g., n-hexyl, 1-methylpentyl, 2-methylpentyl, 4-methylpentyl, 3,3-dimethylbutyl, 1-ethyl-butyl, 2-ethylbutyl, cyclopentylmethyl, cyclohexyl, etc.), heptyl (e.g., n-heptyl, 1-methylhexyl, 4-methylhexyl, 5-methylhexyl, cyclohexylmethyl, etc.), octyl (e.g., n-octyl, tert-octyl, 1-methylheptyl, 2-ethylhexyl, 2-propylpentyl, etc.), nonyl (e.g., n-nonyl, 2,2-dimethylheptyl, etc.), and the like.

In one example, R¹, R² and R¹¹ to R¹³ in Chemical Formulas 1 and 2 are methyl or hydrogen, and at least two of R¹, R² and R¹¹ to R¹³ may be hydrogen. More specifically, the siloxane-based polymer may be a compound in which R¹ and R² of Chemical Formula 1 are each independently methyl and hydrogen, and R¹¹ to R¹³ of Chemical Formula 2 are each independently methyl or hydrogen (e.g., polymethylhydrosiloxane whose terminal end group is a trimethylsilyl group or a dimethylhydrosilyl group); a compound in which some R¹ and R² of Chemical Formula 1 are methyl and hydrogen, respectively, both the remaining R¹ and R² are methyl, and R¹¹ to R¹³ of Chemical Formula 2 are each independently methyl or hydrogen (e.g., poly(dimethylsiloxane-co-methylhydrosiloxane) whose terminal end group is a trimethylsilyl group or a dimethylhydrosilyl group); or a compound in which both R¹ and R² of Chemical Formula 1 are methyl, at least one of R¹¹ to R¹³ of Chemical Formula 2 is hydrogen, and the remainder are each independently methyl or hydrogen (e.g., polydimethylsiloxane in which either or both of the terminal end groups are dimethylhydrosilyl groups).

The siloxane-based compound may have a number average molecular weight (Mn) in the range of 200 to 4,000 as an example. Specifically, the lower limit of the number average molecular weight of the siloxane-based polymer may be, for example, 200 or more, 250 or more, 300 or more, or 350 or more, and the upper limit thereof may be, for example, 3,500 or less, 3,000 or less, 2,500 or less, 2,000 or less, 1,500 or less, or 1,000 or less. When the number average molecular weight of the siloxane-based polymer satisfies the above range, it is possible to prevent the problems that during the crosslinking process with (meth)acrylic-based polyol which is performed at room temperature or higher, the siloxane-based polymer volatilizes and the degree of matrix crosslinking decreases, or the siloxane-based polymer has poor compatibility with other components of the photopolymer composition and thus, phase separation occurs between the components, thereby allowing the holographic recording medium formed from the photopolymer composition to exhibit excellent optical recording characteristics and excellent durability under high temperature/high humidity conditions.

The number average molecular weight means a number average molecular weight (unit: g/mol) converted in terms of polystyrene determined by GPC method. In the process of determining the number average molecular weight in terms of polystyrene measured by the GPC method, a commonly known analyzing device, a detector such as a refractive index detector, and an analytical column can be used, and commonly applied conditions for temperature, solvent, and flow rate can be used. Specific examples of the measurement conditions may include a temperature of 30° C., tetrahydrofuran solvent and a flow rate of 1 mL/min.

The (meth)acrylic-based polyol may mean a polymer in which one or more, specifically two or more, hydroxy groups are bonded to the main chain or side chain of a (meth)acrylate-based polymer. Unless specifically stated otherwise, “(meth)acrylic (based)” as used herein refers to acrylic (based) and/or methacrylic (based), which is a term that encompasses all of acrylic (based), methacrylic (based), or a mixture of acrylic (based) and methacrylic (based).

The (meth)acrylic-based polyol is a homopolymer of a (meth)acrylate-based monomer having a hydroxy group, or a copolymer of two or more types of (meth)acrylate-based monomers having a hydroxy group, or a copolymer of a (meth)acrylate-based monomer having a hydroxy group and a (meth)acrylate-based monomer having no hydroxy group. As used herein. “copolymer” is a term that encompasses random all of a copolymer, a block copolymer and a graft copolymer, unless otherwise specified.

The (meth)acrylate-based monomer having a hydroxy group may include, for example, hydroxyalkyl (meth)acrylate, hydroxyaryl (meth)acrylate, or the like, the alkyl is an alkyl having 1 to 30 carbon atoms, and the aryl may be an aryl having 6 to 30 carbon atoms. Further, the (meth)acrylate-based monomer having no hydroxy group may include, for example, an alkyl (meth)acrylate-based monomer, an aryl (meth)acrylate-based monomer, or the like, the alkyl may be an alkyl having 1 to 30 carbon atoms, and the aryl may be an aryl having 6 to 30 carbon atoms.

The (meth)acrylic-based polyol may have a weight average molecular weight (Mw) in the range of 150,000 to 1,000,000 as an example. The weight average molecular weight means a weight average molecular weight converted in terms of polystyrene measured by the GPC method as described above. For example, the lower limit of the weight average molecular weight may be 150,000 or more, 200,000 or more, or 250,000 or more, and the upper limit thereof may be, for example, 900,000 or less, 850,000 or less, 800,000 or less, 750,000 or less, 700,000 or less, 650,000 or less, 600,000 or less, 550,000 or less, 500,000 or 450,000 or less. When the weight average molecular weight of the (meth)acrylic-based polyol satisfies the above range, the polymer matrix sufficiently exerts the function as a support and thus, the recording properties for optical information less decrease even after the usage time has passed, and sufficient flexibility is imparted to the polymer matrix, thereby being able to improve the mobility of components (e.g., photoreactive monomer or plasticizer, etc.) contained in the photopolymer composition, and minimize the decrease in recording characteristics for optical information.

In order to adjust the crosslinking density of the (meth)acrylic-based polyol by the siloxane-based polymer at a level that is advantageous for ensuring the function of the holographic recording medium, the hydroxyl equivalent of the (meth)acrylic-based polyol may be adjusted to an appropriate level.

Specifically, the hydroxyl (—OH) equivalent of the (meth)acrylic-based polyol may be, for example, in the range of 500 to 3,000 g/equivalent. More specifically, the lower limit of the hydroxyl group (—OH) equivalent of the (meth)acrylic-based polyol may be 600 g/equivalent or more, 700 g/equivalent or more, 800 g/equivalent or more, 900 g/equivalent or more, 1000 g/equivalent or more, 1100 g/equivalent or more, 1200 g/equivalent or more, 1300 g/equivalent or more, 1400 g/equivalent or more, 1500 g/equivalent or more, 1600 g/equivalent or more, 1700 g/equivalent or more, or 1750 g/equivalent or more. And, the upper limit of the hydroxyl group (—OH) equivalent of the (meth)acrylic-based polyol may be 2900 g/equivalent or less, 2800 g/equivalent or less, 2700 g/equivalent or less, 2600 g/equivalent or less, 2500 g/equivalent or less, 2400 g/equivalent or less, 2300 g/equivalent or less, 2200 g/equivalent or less, 2100 g/equivalent or less, 2000 g/equivalent or less, or 1900 g/equivalent or less. The hydroxyl (—OH) equivalent of the (meth)acrylic-based polyol is the equivalent (g/equivalent) of one hydroxy functional group, which is the value obtained by dividing the weight average molecular weight of the (meth)acrylic-based polyol by the number of hydroxy functional groups per molecule. As the equivalent value is smaller, the functional group density is higher, and as the equivalent value is larger, the functional group density is smaller. When the hydroxyl (—OH) equivalent of the (meth)acrylic-based polyol satisfies the above range, the polymer matrix has an appropriate crosslinking density and thus, sufficiently performs the role of a support, and the mobility of the components included in the photopolymer layer is improved, which allows the initial refractive index modulation value to be maintained at an excellent level even as time passes without the problem of collapsing the boundary surfaces of the diffraction gratings generated after recording, thereby minimizing the decrease in recording characteristics for optical information.

For example, the (meth)acrylic-based polyol may have a glass transition temperature (Tg) in the range of −60 to ˜10° C. Specifically, the lower limit of the glass transition temperature may be, for example, −55° C. or more, −50° C. or more, −45° C. or more, −40° C. or more, −35° C. or more, −30° C. or more, or −25° C. or more, and the upper limit thereof may be, for example, −15° C. or less, −20° C. or less, −25° C. or less, −30° C. or less, or −35° C. or less. If the above glass transition temperature range is satisfied, it is possible to lower the glass transition temperature without significantly reducing the modulus of the polymer matrix, thereby increasing the mobility (fluidity) of other components in the photopolymer composition, and also improving the moldability of the photopolymer composition. The glass transition temperature can be measured using a known method, for example, DSC (Differential Scanning calorimetry) or DMA (dynamic mechanical analysis).

The refractive index of the (meth)acrylic-based polyol may be, for example, 1.40 or more and less than 1.50. Specifically, the lower limit of the refractive index of the (meth)acrylic-based polyol may be, for example, 1.41 or more, 1.42 or more, 1.43 or more, 1.44 or more, 1.45 or more, or 1.46 or more, and the upper limit thereof may be, for example, 1.49 or less, 1.48 or less, 1.47 or less, 1.46 or less, or 1.45 or less. When the (meth)acrylic-based polyol has a refractive index within the above-mentioned range, it can contribute to increasing the refractive index modulation. The refractive index of the (meth)acrylic-based polyol is a theoretical refractive index, and can be calculated using the refractive index (value measured using an Abbe refractometer at 25° C.) of the monomer used for preparing the (meth)acrylic-based polyol and the fraction (molar ratio) of each monomer.

The (meth)acrylic-based polyol and siloxane-based polymer may be used so that the molar ratio (SiH/OH) of the silane functional group (Si—H) of the siloxane-based polymer to the hydroxyl group (—OH) of the (meth)acrylic-based polyol is 0.80 to 3.5. That is, the type and content of the siloxane-based polymer and the (meth)acrylic-based polyol can be selected so as to satisfy the molar ratio when forming the polymer matrix. The lower limit of the molar ratio (SiH/OH) may be, for example, 0.81 or more, 0.85 or more, 0.90 or more, 0.95 or more, 1.00 or more, or 1.05 or more, and the upper limit thereof may be, for example, 3.4 or less, 3.3 or less, 3.2 or less, 3.05 or less, or 3.0 or less. When satisfying the above molar ratio (SiH/OH) range, the polymer matrix is crosslinked at an appropriate crosslinking density, so that reliability under high temperature/high humidity conditions is improved, and a sufficient refractive index modulation value can be realized.

The Pt-based catalyst may be, for example, Karstedt's catalyst, and the like. The precursor of the polymer matrix may optionally further include rhodium-based catalysts, iridium-based catalysts, rhenium-based catalysts, molybdenum-based catalysts, iron-based catalysts, nickel-based catalysts, alkali metal or alkaline earth metal-based catalysts, Lewis acids-based or carbene-based non-metallic catalysts, in addition to the Pt-based catalyst.

On the other hand, the photopolymer composition of the above embodiment is characterized in that when constituting a photoreactive monomer as a recording monomer, the content of a monofunctional monomer such as a low-molecular-weight acrylate is adjusted in a specific amount to control the thickness of the erosion layer.

At this time, according to the present specification, the “erosion layer” means that in a holographic recording medium including a photopolymer film in which a coating layer containing a photopolymer composition (a coating layer including a holographic recording layer) is formed on a base material, erosion of monofunctional monomers occurs in the base layer by the addition of a monofunctional monomer among the recording monomers for hologram recording, so that erosion phenomena occur in film quality.

Therefore, the photopolymer film according to one embodiment of the invention may include a substrate film and a coating layer including a photopolymer composition. Additionally, an erosion layer may be further included between the substrate film and the recording layer.

Specifically, a holographic recording medium can be prepared by irradiating an object beam and a reference beam onto the photopolymer layer formed from the photopolymer composition. Due to the interference field between an object beam and a reference beam, photopolymerization of the photoreactive monomer is suppressed or does not occur in the destructive interference region, and photopolymerization of the photoreactive monomer occurs in the constructive interference region. As the photoreactive monomer is continuously consumed in the constructive interference region, a concentration difference occurs between the photoreactive monomers in the destructive interference region and the constructive interference region, and as a result, the photoreactive monomer in the destructive interference region diffuses into the constructive interference region. A diffraction grating is generated by the refractive index modulation thus generated.

Therefore, the photoreactive monomer may include a compound having a higher refractive index than the polymer matrix in order to realize the above-mentioned refractive index modulation. However, all photoreactive monomers contained in the photopolymer composition of one embodiment are not limited to those having a higher refractive index than the polymer matrix, and at least a part of the photoreactive monomers may have a higher refractive index than the polymer matrix, so as to realize a high refractive index modulation value.

The photoreactive monomer comprises a monofunctional monomer and a polyfunctional monomer. Wherein, the polyfunctional monomer may be any one or more selected from the group consisting of a difunctional monomer and a trifunctional monomer.

Generally, if the ratio of the polyfunctional monomer in the photopolymer composition is too high, the recording efficiency is reduced, the haze increases due to compatibility, and the peel adhesive force and adhesion characteristics decreases, so that heat resistance and moist heat resistance reliability due to external environmental factors may also become poor. Further, if the ratio of the monofunctional monomer is too high, there is a problem that the recording efficiency decreases.

If the ratio of the low-molecular-weight acrylate used as the monofunctional monomer is adjusted, it has a high refractive index and thus makes it easier to invade the base layer while also contributing to refractive index modulation by photoreaction, so that it can induce an erosion layer in the coating layer containing the photopolymer composition of the holographic recording medium and also contribute to high heat resistance and moist heat resistance reliability. Thus, in the present invention, as the degree of induction of the erosion layer is adjusted by adjusting the content of the monofunctional monomer in the recording monomer, it is possible to exhibit excellent effects in all aspects of photopolymer properties such as heat resistance, moist heat resistance reliability, haze, peel adhesive force and adhesion characteristics while being excellent in recording efficiency.

Specifically, the photopolymer film has the feature that an erosion layer thickness in the film including the coating layer may satisfy 10% or more and 50% or less of the total thickness of the film including the coating layer by adjusting the content of the monofunctional monomer.

In other words, the photopolymer film has the feature that the thickness ratio of the erosion layer to the coating layer satisfies the condition of the following Equation 1.

$$10 \% \leq Thickness of the erosion layer among the coating layer of the photopolymer folm / Total thickness of the coating layer of the phototpolymer film \times 100 \leq 50 \% \qquad [ Equation 1 ]$$

Further, as the monofunctional monomer is included in a specific ratio among the photoreactive monomer, the formed holographic recording medium has a diffraction efficiency of more than 90% even at a thin thickness, a heat resistance and moist heat resistance reliability of 10 nm or less, a haze of 1.5% or less, a peel adhesive force (180° peel test) of 1000 g/25 mm or more and an adhesion of 4B or more.

At this time, the monofunctional monomer may be contained in an amount of 42 to 55 parts by weight, 43 to 53 parts by weight, or 43 to 52 parts by weight based on 100 parts by weight of the photoreactive monomer. If the content of the monofunctional monomer is 40 parts by weight or less, there are problems that the recording efficiency, heat resistance and moist heat resistance reliability, peel adhesive force and adhesion are defective, and if the content of the monofunctional monomer is 55 parts by weight or more, there is a problem that the recording efficiency is lowered. More specifically, while mixing the monofunctional monomer with the polyfunctional monomer based on 100 parts by weight of the total weight of the photoreactive monomer, the ratio thereof is adjusted, so that the monofunctional monomer content of the total photoreactive monomers can be adjusted in the range of 42 to 55 parts by weight.

The monofunctional monomer may be a monofunctional (meth)acrylate monomer. Specifically, the monofunctional monomer may have a weight average molecular weight of 50 g/mol to 400 g/mol, or 200 g/mol to 300 g/mol. The weight average molecular weight refers to the weight average molecular weight converted in terms of polystyrene measured by the GPC method.

More specifically, the monofunctional monomer may include at least one monofunctional (meth)acrylate monomer selected from the group consisting of phenoxy benzyl (meth)acrylate, o-phenylphenol ethylene oxide (meth)acrylate, benzyl (meth)acrylate, 2-(phenylthio)ethyl (meth)acrylate and biphenylmethyl (meth)acrylate.

The chain length of the monofunctional monomer can be adjusted by a combination of the one or more monofunctional monomers to exhibit the weight average molecular weight range.

More specifically, the monofunctional monomer may include, for example, at least one selected from the group consisting of benzyl (meth)acrylate (M1182 having a refractive index of 1.5140, Miwon Specialty Chemical), phenoxybenzyl (meth)acrylate (M1122 having a refractive index of 1.565, Miwon Specialty Chemical), O-phenylphenol (ethylene oxide) (meth)acrylate (O-phenylphenol (EO) (meth)acrylate; M1142 having a refractive index of 1.577, Miwon Specialty Chemical), and 2-phenylthioethyl (meth)acrylate (M1162 having a refractive index of 1.560, Miwon Specialty Chemical).

Further, the polyfunctional monomer used as a recording monomer may include a polyfunctional (meth)acrylate monomer.

Specifically, the polyfunctional monomer may include at least one selected from the group consisting of bifunctional and trifunctional monomers having 2 to 3 photoreactive functional groups. At this time, the photoreactive functional group may be, for example, a (meth)acryloyl group, a vinyl group, a thiol group, or the like. More specifically, the photoreactive functional group may be a (meth)acryloyl group.

Examples of the polyfunctional monomer include polyfunctional (meth)acrylate monomer having a refractive index of 1.5 or more, or 1.53 or more, or 1.5 to 1.7, and such polyfunctional (meth)acrylate monomers having a refractive index of 1.5 or more, or 1.53 or more, or 1.5 to 1.7 may include a halogen atom (bromine, iodine, etc.), sulfur(S), phosphorus (P), or an aromatic ring.

More specific examples of the polyfunctional (meth)acrylate monomer having a refractive index of 1.5 or more include at least one selected from bisphenol A modified diacrylate series, fluorene acrylate series (HR6022, etc.—Miwon Specialty Chemical), bisphenol fluorene epoxy acrylate series (HR6100, HR6060, HR6042, etc.—Miwon Specialty Chemical), halogenated epoxy acrylate series (HR1139, HR3362, etc.—Miwon Specialty Chemical), and the like.

More specifically, the polyfunctional monomer include at least one selected from the group consisting of 9,9-bis [4-(2-acryloyloxyethyloxy)phenyl]fluorene, bisphenol A (ethylene oxide)₂₋₁₀ di(meth)acrylate (bisphenol A (EO)₂₋₁₀ (meth)acrylate; M240 having a refractive index of 1.537, M241 having a refractive index of 1.529, M244 having a refractive index of 1.545, M245 having a refractive index of 1.537, M249 having a refractive index of 1.542, M2100 having a refractive index of 1.516, M2101 having a refractive index of 1.512, Miwon Specialty Chemical), bisphenol A epoxy di(meth)acrylate (PE210 having a refractive index of 1.557, PE2120A having a refractive index of 1.533, PE2120B having a refractive index of 1.534, PE2020C having a refractive index of 1.539, PE2120S having a refractive index of 1.556, Miwon Specialty Chemical), bisfluorene di(meth)acrylate (HR6022 having a refractive index of 1.600, HR6040 having a refractive index of 1.600, HR6042 having a refractive index of 1.600, Miwon Specialty Chemical), and modified bisphenol fluorene di(meth)acrylate (HR 6060 having a refractive index of 1.584, HR6100 having a refractive index of 1.562, HR6200 having a refractive index of 1.530, Miwon Specialty Chemical).

On the other hand, the polyfunctional monomer may have a weight average molecular weight of 200 g/mol to 1000 g/mol, or 400 g/mol to 600 g/mol. The weight average molecular weight means a weight average molecular weight converted in terms of polystyrene measured by the GPC method.

The photopolymer composition of one embodiment may contain a photoreactive monomer in an amount of 50 to 300 parts by weight based on 100 parts by weight of the polymer matrix or the precursor thereof. For example, the lower limit of the content of the photoreactive monomer may be 50 parts by weight or more, 55 parts by weight or more, or 60 parts by weight or more, and the upper limit thereof may be 300 parts by weight or less, 290 parts by weight or less, 285 parts by weight or less, or 280 parts by weight or less. At this time, the content of the polymer matrix that serves as a reference means the content (weight) of the (meth)acrylic-based polyol and siloxane-based polymer forming the matrix. When the above range is satisfied, it is advantageous to ensure excellent optical recording characteristics and durability in a high temperature/high humidity environment.

The photopolymer composition includes a photoinitiator. The photoinitiator is a compound which is activated by light or actinic radiation and initiates polymerization of a compound containing a photoreactive functional group such as the photoreactive monomer.

As the photoinitiator, commonly known photoinitiators can be used without particular limitation, but specific examples thereof include a photoradical polymerization initiator, a photocationic polymerization initiator, or a photoanionic polymerization initiator.

Specific examples of the photoradical polymerization initiator include imidazole derivatives, bisimidazole derivatives, N-aryl glycine derivatives, organic azide compounds, titanocene, aluminate complex, organic peroxide, N-alkoxypyridinium salts, thioxanthone derivatives, amine derivatives or the like. More specifically, examples of the photoradical polymerization initiator include 3-di(t-butyldioxycarbonyl)benzophenone, 3,3′,4,4″-tetrakis (t-butyldioxycarbonyl)benzophenone, 3-phenyl-5-isoxazolone,2 benzimidazole, bis(2,4,5-triphenyl) imidazole, 2,2-dimethoxy-1,2-diphenylethane-1-one (product name: Irgacure 651/manufacturer: BASF), 1-hydroxy-cyclohexyl-phenyl-ketone (product name: Irgacure 184/manufacturer: BASF), 2-benzyl-2-dimethylamino-1-(4-morpholinophenyl)-butanone-1 (product name: Irgacure 369/manufacturer: BASF), and bis(η5-2,4-cyclopentadiene-1-yl)-bis(2,6-difluoro-3-(1H-pyrrole-1-yl)-phenyl) titanium (product name: Irgacure 784/manufacturer: BASF), Ebecryl P-115 (manufacturer: SK entis), or the like.

The photocationic polymerization initiator may include a diazonium salt, a sulfonium salt, or an iodonium salt, and examples thereof include sulfonic acid esters, imidosulfonates, dialkyl-4-hydroxysulfonium salts, arylsulfonic acid-p-nitrobenzyl esters, silanol-aluminum complexes, (η6-benzene) (η5-cyclopentadienyl) iron (II), or the like. In addition, benzoin tosylate, 2,5-dinitrobenzyltosylate, N-tosylphthalic acid imide, or the like can be mentioned. More specific examples of the photocationic polymerization initiator include commercially available products such as Cyracure UVI-6970, Cyracure UVI-6974 and Cyracure UVI-6990 (manufacturer: Dow Chemical Co. in USA), Irgacure 264 and Irgacure 250 (manufacturer: BASF) or CIT-1682 (manufacturer: Nippon Soda).

The photoanionic polymerization initiator may be borate salt, for example, butyryl chlorine butyl triphenyl borate, or the like. More specific examples of the photoanionic polymerization initiator include commercially available products such as Borate V (manufacturer: Spectra Group).

In addition, the photopolymer composition of the embodiment may include monomolecular (type I) initiator or bimolecular (type II) initiator. The (type I) system for free radical photopolymerization may include, for example, an aromatic ketone compounds in combination with a tertiary amine, such as benzophenone, alkylbenzophenone, 4,4′-bis(dimethylamino)benzophenone (Michler's ketone), anthrone and halogenated benzophenone or a mixture of these types. The bimolecular (type II) initiator may include benzoin and derivatives thereof, benzyl ketal, acylphosphine oxide, for example, 2,4,6-trimethylbenzoyldiphenylphosphine oxide, bisacylophosphine oxide, phenylglyoxyl ester, camphorquinone, alpha-aminoalkylphenone, alpha-dialkoxyacetophenone, 1-[4-(phenylthio)phenyl]octane-1,2-dione 2-(O-benzoyloxime), alpha-hydroxyalkylphenone, and the like.

The photopolymer composition may include an initiator in the range of 0.1 to 10.0 parts by weight based on 100 parts by weight of the polymer matrix component. Specifically, the lower limit of the content of the initiator may be, for example, 0.2 parts by weight or more, 0.3 parts by weight or more, 0.4 parts by weight or more, 0.5 parts by weight or more, 0.6 parts by weight or more, 0.7 parts by weight or more, 0.8 parts by weight or more, or 0.9 parts by weight or more. And the upper limit thereof may be, for example, 5.0 parts by weight or less. When the above range is satisfied, it is advantageous for ensuring optical recording characteristics and durability at high temperature/high humidity.

The photopolymer composition may further include a fluorinated compound. The fluorine-based compound is a non-reactive compound and can be used as a plasticizer.

Specifically, the fluorinated compound may include at least one functional group selected from the group consisting of an ether group, an ester group, and an amide group, and at least two difluoromethylene groups.

The photopolymer composition may further include a fluorinated compound represented by the following Chemical Formula 3.

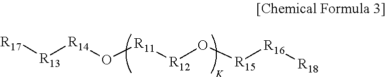

wherein, in Chemical Formula 3,
R₁₁ and R₁₂ are each independently a difluoromethylene group,
R₁₃ and R₁₆ are each independently a methylene group,
R₁₄ and R₁₅ are each independently a difluoromethylene group,
k is an integer of 1 to 10, and
R₁₇ and R₁₈ are each independently a straight-chain or branched-chain alkyl group having 1 to 10 carbon atoms or a functional group of the following Chemical Formula 4,

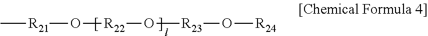

wherein, in Chemical Formula 4,
R₂₁, R₂₂ and R₂₃ are each independently a straight-chain or branched-chain alkylene group having 1 to 10 carbon atoms,
R₂₄ is a straight-chain or branched-chain alkyl group having 1 to 10 carbon atoms, and
l is an integer of 1 to 30.

More specifically, in Chemical Formula 3, R₁₁ and R₁₂ are each independently a difluoromethylene group, R₁₃ and R₁₆ are each independently a methylene group, R₁₄ and R₁₅ are each independently a difluoromethylene group, R₁₇ and R₁₈ are each independently a 2-methoxyethoxymethoxy group, and k is an integer of 2.

As the fluorinated compound, one having a lower refractive index than the photoreactive monomer can be used. In this case, the refractive index of the polymer matrix can be lowered and the refractive index modulation can be made larger.

The fluorinated compound may have a low refractive index of 1.45 or less. Specifically, the upper limit of the refractive index of the fluorinated compound may be, for example, 1.44 or less, 1.43 or less, 1.42 or less, 1.41 or less, 1.40 or less, 1.39 or less, 1.38 or less, or 1.37 or less, and the lower limit of the refractive index may be, for example, 1.30 or more, 1.31 or more, 1.32 or more, 1.33 or more, 1.34 or more, or 1.35 or more. Since a fluorinated compound having a lower refractive index than the above-mentioned photoreactive monomer is used, the refractive index of the polymer matrix can be lowered, and the refractive index modulation with the photoreactive monomer can be made larger.

The fluorinated compound may include 20 to 200 parts by weight based on 100 parts by weight of the polymer matrix or the precursor thereof. Specifically, the lower limit of the content of the fluorinated compound may be, for example, 20 parts by weight or more, 25 parts by weight or more, 30 parts by weight or more, 35 parts by weight or more, or 40 parts by weight or more, and the upper limit thereof may be, for example, 200 parts by weight or less, 190 parts by weight or less, or 180 parts by weight or less. If the above range is satisfied, it is advantageous for ensuring excellent optical recording characteristics. When the content of the fluorinated compound is less than the above range, The refractive index modulation value after recording may be lowered due to a lack of low refractive components. In addition, when the fluorinated compound content exceeds the above range, there may be a problem that haze occurs due to compatibility issue between components contained in the coating layer, or some fluorinated compounds are eluted onto the surface of the coating layer.

The fluorinated compound may have a weight average molecular weight of 300 or more. Specifically, the lower limit of the weight average molecular weight of the fluorinated compound may be, for example, 350 or more, 400 or more, 450 or more, 500 or more, 550 or more, or 600 or more, and the upper limit thereof may be, for example, 1000 or less, 900 or less, 800 or less, 700 or less, 600 or less, or 500 or less. Considering refractive index modulation, compatibility with other components, elution problems of fluorinated compounds, and the like, it is preferable that the above weight average molecular weight range is satisfied. At this time, the weight average molecular weight means the weight average molecular weight converted in terms of polystyrene measured by the GPC method as described above.

In addition, the photopolymer composition may further include at least one selected from the group consisting of a dye, a catalyst, an antifoaming agent, and a plasticizer.

Specifically, the photopolymer composition may further include a photosensitizing dye. The photosensitizing dye serves as a photosensitizing pigment to sensitize the photoinitiator. More specifically, the photosensitizing dye can be stimulated by the light irradiated on the photopolymer composition and can also serve as an initiator to initiate polymerization of the monomer and the cross-linking monomer. The photopolymer composition can contain 0.01% by weight to 30% by weight, or 0.05% by weight to 20% by weight of the photosensitizing dye.

Examples of the photosensitizing dye are not particularly limited, and various compounds commonly known in the art can be used. Specific examples of the photosensitizing dye include sulfonium derivative of ceramidonine, new methylene blue, thioerythrosine triethylammonium, 6-acetylamino-2-methylceramidonin, eosin, erythrosine, rose bengal, thionine, basic yellow, Pinacyanol chloride, Rhodamine 6G, Gallocyanine, ethyl violet, Victoria blue R, Celestine blue, QuinaldineRed, Crystal Violet, Brilliant Green, Astrazon orange G, Darrow Red, Pyronin Y, Basic Red 29, pyrylium iodide, Safranin O, Cyanine, Methylene Blue, Azure A, or a combination of two or more thereof.

The photopolymer composition can include a catalyst which is commonly known for promoting polymerization of the polymer matrix or the photoreactive monomer. Examples of the catalyst include platinum-based catalysts such as Karstedt's catalyst, rhodium-based catalysts, iridium-based catalysts, rhenium-based catalysts, molybdenum-based catalysts, iron-based catalysts, nickel-based catalysts, alkali metal and alkaline earth metal catalysts. As the non-metal catalyst, a Lewis acids-based catalyst, a carbene-based catalyst, or the like can be used.

The photopolymer composition can further include other additives.

Examples of the other additives include a defoaming agent or a phosphate-based plasticizer, and the defoaming agent can be a silicone-based reactive additive, for example, Tego Rad 2500. Examples of the plasticizer include phosphate compounds such as tributyl phosphate, and the plasticizer can be added in a weight ratio of 1:5 to 5:1 together with the fluorinated compound. The plasticizer can have a refractive index of less than 1.5 and a molecular weight of 700 or less.

The photopolymer composition can include an organic solvent. Non-limiting examples of the organic solvent include ketones, alcohols, acetates, ethers, and a mixture of two or more thereof.

Specific examples of the organic solvent include ketones such as methyl ethyl ketone, methyl isobutyl ketone, acetylacetone or isobutyl ketone; alcohols such as methanol, ethanol, n-propanol, i-propanol, n-butanol, i-butanol or t-butanol; acetates such as ethyl acetate, i-propyl acetate, or polyethylene glycol monomethyl ether acetate; ethers such as tetrahydrofuran or propylene glycol monomethyl ether; or a mixture of two or more thereof.

The organic solvent can be added at the time of mixing the respective components contained in the photopolymer composition, or can be contained in the photopolymer composition by adding the respective components dispersed or mixed in an organic solvent. When the content of the organic solvent in the photopolymer composition is too low, flowability of the photopolymer composition may be lowered, resulting in the occurrence of defects such as striped patterns on the finally produced film. In addition, when too much organic solvent is added, the solid content is lowered, and coating and film formation are not sufficient, so that physical properties and surface characteristics of the film may be deteriorated and defects may occur during the drying and curing process. Thus, the photopolymer composition can include an organic solvent such that the total solid content concentration of the components contained is 1% by weight to 70% by weight, or 2% by weight to 50% by weight.

Specifically, the photopolymer composition may include a solvent so that the concentration of the total solid content of the components contained in the composition is 1 to 70% by weight. More specifically, the photopolymer composition may include a solvent so that the concentration of the total solid content of the components contained in the composition is 2% by weight or more, 5% by weight or more, 10% by weight or more, or 20% by weight or more, and 65% by weight or less, 60% by weight or less, 55% by weight or less, or 50% by weight or less. When the content of the solvent in the composition is too low, flowability of the composition may be lowered, resulting in the occurrence of defects such as striped patterns on the finally produced film. In addition, when too much organic solvent is added, the solid content is lowered, and coating and film formation are not sufficient, so that physical properties and surface characteristics of the photopolymer film may be deteriorated and defects may occur during the drying and curing process

The photopolymer composition can be used for holographic recording.

On the other hand, according to another embodiment of the invention, a photopolymer film comprising a substrate film; and a coating layer including the photopolymer composition can be provided.

The coating layer may include an erosion layer and a recording layer.

As mentioned above, the photopolymer film according to one embodiment may further include an erosion layer between the substrate film and the recording layer. For example, the erosion layer and the recording layer may be formed sequentially on the substrate film. Further, it can be referred to as a coating layer including the erosion layer and the recording layer. Further, the coating layer may be a photopolymer layer formed of a photopolymer composition.

The composition of the photopolymer composition used as a coating liquid during the production of a photopolymer film can be adjusted to form an erosion layer on the substrate film. For example, the photopolymer composition may include a polymer matrix or a precursor thereof including a siloxane-based polymer, a photoreactive monomer, and a solvent, whereby the recording layer may include a polymer matrix including a siloxane-based polymer and a photoreactive monomer.

Further, when the photopolymer composition of one embodiment is used, the thickness ratio of the erosion layer in the coating layer in the photopolymer film can be adjusted from 10% to 50% by adjusting the content of monofunctional monomers contained in the recording monomer, whereby it is not affected by the external environment of high temperature and high humidity, prevents deformation of the outside shape and achieves excellent durability. Therefore, the holographic recording medium can have excellent heat resistance and moist heat resistance reliability, haze, peel adhesive force and adhesion while satisfying a recording efficiency of 90% or more. In particular, it has excellent heat resistance and moist heat resistance under high temperature and high humidity, and is excellent in long-term storage stability, thereby making it possible to optimize the recording characteristics of the holographic recording medium.

Further, if the holographic medium is used, it is possible to provide a hologram that has a thinner thickness and more effectively realizes a greatly improved refractive index modulation value and high diffraction efficiency as compared to previously known holograms.

The coating layer of the photopolymer film includes a crosslinking type matrix. For example, the photopolymer film may include or be formed from a composition that includes at least a crosslinked type matrix or a precursor thereof. In embodiments of this application, the coating layer may include or be formed from a composition that includes a crosslinked type matrix or a precursor thereof, a photoreactive monomer, and a photoinitiator.

In the photopolymer film, the coating layer includes an erosion layer and a recording layer, wherein the thickness ratio of the erosion layer to the coating layer satisfies the condition of the following Equation 1.

$$10 \% \leq Thickness of the erosion layer among the coating layer of the photopolymer folm / Total thickness of the coating layer of the phototpolymer film \times 100 \leq 50 \% \qquad [ Equation 1 ]$$

If the thickness ratio of the erosion layer is 10% or less, there is a problem that heat resistance and moist heat resistance reliability, peel adhesive force and adhesion are defective, and if the thickness ratio is 50% or more, there is a problem that the thickness of the recording layer that is actually recorded becomes thinner, and the recording efficiency decreases.

The coating layer (i.e., photopolymer layer) of the photopolymer film is a holographic recording layer and may have a thickness ranging from 5.0 to 40.0 μm. Specifically, the thickness of the coating layer may be, for example, 6 μm or more, 7 μm or more, 8 μm or more, 9 μm or more, 10 μm or more, 11 μm or more, 12 μm or more, 13 μm or more, 14 (or more, or 15 μm or more. And, the upper limit of the thickness may be, for example, 35 μm or less or 30 μm or less, specifically 29 μm or less, 28 μm or less, 27 μm or less, 26 μm or less, 25 μm or less, 24 μm or less, 23 μm or less, 22 μm or less, 21 μm or less, 20 μm or less, 19 μm or less, or 18 μm or less. The holographic recording medium of the present invention has excellent refractive index modulation, diffraction efficiency, and driving reliability even when it has a thin thickness within the above-mentioned range. The method for preparing the photopolymer film is as follows.

When the photopolymer composition is applied to the substrate film, the photoreactive monomer and solvent may dissolve and penetrate at least a portion of the substrate film. Subsequently, when the drying process for forming the coating layer proceeds, the polymer matrix containing the siloxane-based polymer and the photoreactive monomer may be cured or crosslinked to form an erosion layer. Further, the photoreactive monomer permeated into the substrate film may be physically or chemically bonded to the substrate film.

Therefore, the erosion layer may include a photoreactive monomer, and the erosion layer may be physically or chemically bonded to the substrate film. For example, the physical bonding between the erosion layer and the substrate film can be achieved by physically bonding the photoreactive monomer contained in the erosion layer with the substrate film.

On the other hand, a recording layer may be formed on the erosion layer, and the recording layer may include a polymer matrix including a siloxane-based polymer, a photoreactive monomer, and the like.

As mentioned above, since the inter-erosion layer is formed on the substrate film, the adhesion between the optical film and the recording layer can be greatly improved, the decrease in recording efficiency of the photopolymer film can be minimized, and also excellent mechanical properties such as heat resistance and moist heat resistance reliability can be exhibited. The presence or absence of the erosion layer can be confirmed by photothermal infrared spectroscopic analysis as described above, and the thickness of the erosion layer can be analyzed using a scanning electron microscope.

The erosion layer may have a thickness of 1.0 μm or more, 2.0 μm or more, 2.5 μm or more, and 6.0 μm or less, 5.5 μm or less, 5.0 μm or less, and 4.5 μm or less. If the thickness of the erosion layer is too thin, the adhesion between the substrate film and the recording layer may decrease and the heat resistance and moist heat resistance reliability may decrease, and if the thickness of the erosion layer is too thick, the thickness of the recording layer that is actually recorded becomes rather thin, which may result in low recording efficiency.

The recording layer may have a thickness of 3.0 μm or more, 3.5 μm or more, 4.0 μm or more, and 8.0 μm or less, 7.0 μm or less, 6.8 μm or less, and 6.7 μm or less. If the thickness of the recording layer is too thin, low recording efficiency may be exhibited, and if the thickness of the recording layer is too thick, the thickness of the erosion layer may become thin, and the adhesion between the substrate film and the recording layer may decrease.

The coating layer may have a thickness of 5.0 μm or more, 5.5 μm or more, 6.0 μm or more, and 20.0 μm or less, 15.0 μm or less, and 10.0 μm or less.

The type of the substrate film included in the photopolymer film according to the embodiment is not particularly limited as long as it is a substrate film capable of forming the erosion layer, and one film known in the related technical field may be used. For example, a cellulose ester-based substrate film, a polyester-based substrate film, a poly(meth)acrylate-based substrate film, a polycarbonate-based substrate film, a cycloolefin-based (COP) substrate film, glass, an acrylic substrate film, and the like may be used. Specifically, base materials such as polyethylene terephthalate (PET), triacetyl cellulose (TAC), polycarbonate (PC), cycloolefin polymer (COP), and polymethyl methacrylate (PMMA) may be used.

The thickness of the substrate film may be 20 μm or more, 30 μm or more, 40 μm or more, and 500 μm or less, 300 μm or less, 100 μm or less, 80 μm or less, and 60 μm or less. The substrate film satisfies the above thickness, and thus can exhibit characteristics such as excellent mechanical properties, water resistance, and low moisture permeability.

The photopolymer film can be used for holographic recording applications.

On the other hand, according to another embodiment of the invention, a holographic recording medium including the photopolymer film can be provided.

As mentioned above, the photopolymer film improves heat resistance and moist heat resistance reliability, haze, peel adhesive force and adhesion characteristics, thereby preventing deformation of the outside shape of the photopolymer film due to high temperature/high humidity external environments and optimizing recording efficiency. Therefore, the hologram recording medium including it can also have excellent heat resistance and moist heat resistance reliability, and optimize the recording efficiency.

The photopolymer film can be prepared into a hologram for optical applications in the entire visible range and a near ultraviolet range (300 to 800 nm) through a predetermined exposure process.

As a method of recording a visual hologram on a holographic recording medium including the photopolymer film, commonly known methods can be used without particular limitations.

For example, a visual hologram can be recorded through a method of selectively polymerizing photoreactive monomers contained in the photopolymer film using a coherent laser.

The holographic recording medium of another embodiment can realize a refractive index modulation value (Δn) of 0.020 or more, 0.021 or more, 0.022 or more, 0.023 or more, 0.024 or more, 0.025 or more, 0.026 or more, 0.027 or more, 0.028 or more, 0.029 or more, or 0.030 or more even if the photopolymer layer has a thin thickness of 5 to 30 μm. The upper limit of the refractive index modulation value is not particularly limited, but may be, for example, 0.035 or less.

Further, the photopolymer film and the holographic recording medium including the same may have a diffraction efficiency of 90% or more, heat resistance and moist heat resistance reliability of −10 nm or more and 10 nm or less, a haze of 1.5% or less, a peel adhesive force (180° peel test) of 1000 g/25 mm or more and an adhesion of 4B or more.

Specifically, the photopolymer film and the holographic recording medium including the same according to another embodiment may have a diffraction efficiency of 90% or more. Specifically, the photopolymer film and the holographic recording medium including the same can achieve a diffraction efficiency of 90% or more, 91% or more, 92% or more, or 94% or more at a thickness of 5 μm to 30 μm. Thus, the photopolymer film of another embodiment and the hologram recording medium including the same can achieve excellent diffraction efficiency even if it includes a thin photopolymer layer.

Further, the photopolymer film and the holographic recording medium including the same may adjust the content ratio of the monofunctional monomer among the recording monomers to a specific range, and thus have an absorption wavelength modulation value (Δλ) of about −10 nm or more and 10 nm or less when measuring heat resistance and moist heat resistance reliability under high temperature and high humidity conditions of 65° C., RH 90%, and 72 h. Specifically, the heat resistance reliability may be about −10 nm or more, −9 nm or more, or −8 nm or more, and about 10 nm or less, 8 nm or less, or 6 nm or less. Further, the moist heat resistance reliability may be about −10 nm or more, −8 nm or more, −6 nm or more, −4 nm or more, and about 10 nm or less, 8 nm or less, 6 nm or less, 4 nm or less, 3 nm or less, or 2 nm or less.

Further, the photopolymer film and the holographic recording medium including the same may have a haze of 1.5% or less, a peel adhesive force (180° peel test) of 1000 g/25 mm or more, and an adhesion of 4B or more.

The diffraction efficiency, heat resistance and moist heat resistance reliability, haze, peel adhesive force and adhesion may be measured by the method described in Test Examples described later.

The holographic recording medium of the other embodiment is not limited thereto, but may be a medium in which a reflective hologram or a transmissive hologram is recorded.

The use of the holographic recording medium of the other embodiment is not particularly limited. By way of non-limiting example, the holographic recording medium can be used in applications that are highly likely to be exposed to high temperature/high humidity environments, specifically smart devices such as mobile devices, parts of wearable displays, or automotive parts (e.g. head up displays).

On the other hand, according to another embodiment of the invention, a holographic recording method may be provided, which includes selectively polymerizing photoreactive monomers contained in the photopolymer composition using a coherent laser.

As mentioned above, through the process of mixing and curing the photopolymer composition, it is possible to produce a medium in which no visual hologram is recorded, and a visual hologram can be recorded on the medium through a predetermined exposure process.

A visual hologram can be recorded on the media provided through the process of mixing and curing the photopolymer composition, using known devices and methods under commonly known conditions.

In one example, a method for preparing a holographic recording medium may include the steps of: applying the photopolymer composition in a substrate to form a photopolymer film; and irradiating a coherent laser onto a predetermined region of the photopolymer film and selectively polymerizing a photoreactive monomer and a monofunctional monomer contained in the photopolymer film to record optical information.

The photopolymer composition may be the photopolymer composition of one embodiment described above, and the photopolymer composition has been described in detail above, and therefore, a detailed description thereof is omitted here.

In the step of forming the photopolymer film, a photopolymer composition containing the above-mentioned configuration can first be prepared. When preparing the photopolymer composition, for mixing the respective components contained therein, a mixing device, a stirrer, a mixer, or the like which are commonly known in the art can be used without particular limitation. Further, such a mixing process may be performed at a temperature ranging from 0° C. to 100° C., a temperature ranging from 10° C. to 80° C., or a temperature ranging from 20° C. to 60° C.

In the step of forming the photopolymer film, the prepared photopolymer composition can be applied onto the substrate to form a coating film formed from the photopolymer composition. The coating film can be dried naturally at room temperature or dried at a temperature in the range of 30 to 80° C. This process can induce a hydrosilylation reaction between the hydroxy group of the (meth)acrylic-based polyol remaining unreacted and the silane functional group of the siloxane-based polymer.

On the other hand, according to another embodiment of the invention, an optical element including the holographic recording medium can be provided.

Specific examples of the optical element include optical lenses, mirrors, deflecting mirrors, filters, diffusing screens, diffraction elements, light guides, waveguides, holographic optical elements having projection screen and/or mask functions, medium of optical memory system and light diffusion plate, optical wavelength multiplexers, reflection type, transmission type color filters, and the like.

An example of the optical element including the holographic recording medium may include a hologram display device.

The hologram display device includes a light source unit, an input unit, an optical system, and a display unit. The light source unit is a part that irradiates a laser beam used for providing, recording, and reproducing three-dimensional image information of an object in the input unit and the display unit. Further, the input unit is a part that previously inputs three-dimensional image information of an object to be recorded on the display unit, and for example, three-dimensional information of an object such as the intensity and phase of light for each space can be input into an electrically addressed liquid crystal SLM, wherein an input beam may be used. The optical system may include a mirror, a polarizer, a beam splitter, a beam shutter, a lens, and the like. The optical system can be distributed into an input beam for sending a laser beam emitted from the light source unit to the input unit, a recording beam for sending the laser beam to the display unit, a reference beam, an erasing beam, a reading beam, and the like.

The display unit can receive three-dimensional image information of an object from an input unit, record it on a hologram plate comprising an optically addressed SLM, and reproduce the three-dimensional image of the object. At this time, the three-dimensional image information of the object can be recorded via interference of the input beam and the reference beam. The three-dimensional image information of the object recorded on the hologram plate can be reproduced into a three-dimensional image by the diffraction pattern generated by the reading beam. The erasing beam can be used to quickly remove the formed diffraction pattern. On the other hand, the hologram plate can be moved between a position at which a three-dimensional image is inputted and a position at which a three-dimensional image is reproduced.

### Advantageous Effects

The photopolymer composition according to one embodiment of the invention can efficiently provide a photopolymer layer that not only has excellent recording efficiency, but can also realize higher refractive index modulation values even in a thin thickness range and exhibit excellent durability, reliability, haze, peel adhesive force and adhesion characteristics.

Therefore, according to the present invention, a photopolymer film that realizes a higher refractive index modulation value even in a thin thickness range and prevents deformation of the outside shape due to the external environment even in high temperature and high humidity environments, and has excellent heat and moist heat resistance reliability, haze, peel adhesive force and adhesion characteristics, a holographic recording medium including the same, an optical element and a holographic recording method can be provided.

### BRIEF DESCRIPTION OF THE DRAWINGS

FIG. 1 is a diagram schematically showing a recording device setup or hologram recording according to one embodiment.

FIG. 2 is a diagram showing a spectrum for measuring the diffraction efficiency of a holographic recording medium according to one embodiment.

### DETAILED DESCRIPTION OF THE EMBODIMENTS

Hereinafter, the action and effect of the invention will be described in more detail with reference to specific examples of the invention. However, these examples are presented for illustrative purposes only, and the scope of the invention is not limited thereby in any way.

### PREPARATION EXAMPLE

### Preparation Example 1: Preparation of (Meth)Acrylic-Based Polyol

132 g of butyl acrylate, 420 g of ethyl acrylate, and 48 g of hydroxybutyl acrylate were added to a 2 L jacketed reactor, and diluted with 1200 g of ethyl acetate. The reaction temperature was set to 60˜70° C., and the mixture was stirred for about 30 minutes to 1 hour. 0.42 g of n-dodecyl mercaptan (n-DDM) was further added, and stirring was further performed for about 30 minutes. Then, 0.24 g of AIBN as a polymerization initiator was added, polymerization was carried out at the reaction temperature for 4 hours or more, and kept until the residual acrylate content became less than 1%. Thereby, a (meth)acrylate-based copolymer (weight average molecular weight of about 300,000, OH equivalent of about 1802 g/equivalent) in which the hydroxy group was located in the branched chain was prepared.

### Preparation Example 2: Preparation of Fluorinated Compound

20.51 g of 2,2′-{oxybis [(1,1,2,2-tetrafluoroethane-2,1-diyl)oxy]}bis(2,2-difluoroethan-1-ol) was added to a 1000 mL flask, then dissolved in 500 g of tetrahydrofuran, and 4.40 g of sodium hydride (60% dispersion in mineral oil) was carefully added several times while stirring at 0° C. After stirring at 0° C. for 20 minutes, 12.50 mL of 2-methoxyethoxymethyl chloride was slowly dropped. When it was confirmed by 1H NMR that all of the reactants were consumed, work-up using dichloromethane gave 29 g of a liquid product with a purity of 95% or more in a yield of 98%. The weight average molecular weight of the prepared fluorinated compound was 586, and the refractive index measured with an Abbe refractometer was 1.361.

### Example and Comparative Example: Preparation of Photopolymer Composition, Photopolymer Film and Holographic Medium

### Example 1: Preparation of Photopolymer Composition, Photopolymer Film and Holographic Recording Medium

### (1) Preparation of Photopolymer Composition (Prepared Under Dark Room Conditions)

0.6 g of trimethylsilyl terminated poly(methylhydrosiloxane) (prepared by Sigma-Aldrich, number average molecular weight: about 390) as a siloxane polymer and 33.3 g of (meth)acrylic-based polyol prepared in Preparation Example 1 were first mixed to prepare a mixed solution (SiH/OH molar ratio=1.0).

Then, 14.5 g of the fluorinated compound prepared in Preparation Example 2, 0.1 g of photosensitizing dye HNu-640 (Spectra Group), 0.3 g of silicone-based reactive additive (Tego Rad 2500), and methyl ethyl ketone (MEK) as a solvent were added to the mixed solution, mixed in a state blocking light, and stirred for about 10 minutes with a paste mixer.

Subsequently, for matrix crosslinking, 0.01 g of Karstedt (Pt-based) catalyst was added, and crosslinking was performed at room temperature for 30 minutes or more.

22.6 g of HR 6042 (Miwon Specialty Chemical, refractive index of 1.60) as a high refractive index photoreactive monomer, 3.0 g of low molecular weight acrylate as a monofunctional monomer, a difunctional monomer and Borate V photoinitiator were added to the reaction solution (coating solution), and then further mixed at room temperature for 5 minutes or more to prepare a photopolymer composition with a solid content of 25 wt. %.

At this time, the ratio of the monofunctional monomer is as shown in Table 1 below, and the ratio was adjusted while further adding OPPEA (2-phenylphenoxyethyl acrylate) as a monofunctional monomer, based on 100 parts by weight of the photoreactive monomer, so that the content of the monofunctional monomer was set to 43 parts by weight.

### (2) Preparation of Photopolymer Film and Holographic Recording Medium

The photopolymer composition was coated to a thickness of 8 μm on a TAC substrate having a thickness of 40 μm using a meyer bar, and dried at 60° C. within 10 minutes to prepare a photopolymer film (thickness: 15 μm). Then, the sample was left in a dark room under constant temperature and humidity conditions of about 25° C. and relative humidity of 50RH % for 24 hours or more.

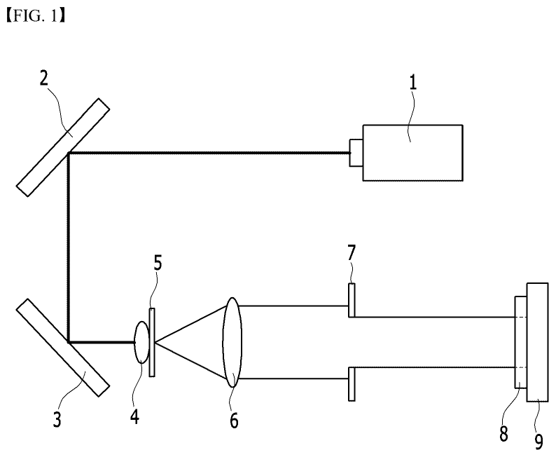

In the photopolymer film thus prepared, the photopolymer layer was laminated so as to be in contact with a slide glass having a thickness of 0.70 mm, and the laser was fixed so as to first pass through the glass surface during recording. Lasers of 660 nm and 532 nm were used for recording, the ratio of the reference beam and the object beam was 1, the recording equipment setup was as shown in FIG. 1, and recording was performed by a reflective slanted method (reference beam=30°, object beam=) 40°.

The holographic recording medium in which the reflective diffraction grating was recorded using a laser was attached to glass and placed in a UV irradiator (Dymax model 2000 flood), and UVA was irradiated at an intensity of 105 mW/cm² for about 1 minute and a photobleaching process was performed to remove the color of the photosensitizing dye and complete the reaction of the photoreactive monomer.

### Examples 2 to 4 and Comparative Examples 1 to 4: Preparation of Photopolymer Composition, Photopolymer Film and Holographic Recording Medium

A photopolymer composition, a photopolymer film, and a holographic recording medium were prepared in the same manner as in Example 1, except that the composition and content of monofunctional or difunctional monomers among the recorded monomers were changed as shown in Table 1 below.

TABLE 1

| | Photoreactive monomer | | |
|---|---|---|---|
| | | Bifunctional | |
| | | monomer (B) | |
| | | 9,9-Bis[4- | |
| | Monofunctional | (2-acryloyloxyethyl- | |
| | monomer (A) | oxy)phenyl]fluorene | |
| | OPPEA or | or Triethylene | |
| | 2-Hydroxyethyl | glycol | Photoreactive |
| | acrylate | dimethacrylate | monomer (A + B) |
| Example 1 | 9.7 g, 43 parts | 12.9 g, 57 parts | 22.6 g, 100 parts |
| | by weight^{a)} | by weight^{b)} | by weight |
| Example 2 | 10.4 g, 46 parts | 12.2 g, 54 parts | |
| | by weight^{a)} | by weight^{b)} | |
| Example 3 | 11.1 g, 49 parts | 11.5 g, 51 parts | |
| | by weight^{a)} | by weight^{b)} | |
| Example 4 | 11.8 g, 52 parts | 10.8 g, 48 parts | |
| | by weight^{a)} | by weight^{b)} | |
| Comparative | 0 | 22.6 g, 100 parts | |
| Example 1 | | by weight^{b)} | |
| Comparative | 6.8 g, 30 parts | 15.8 g, 70 parts | |
| Example 2 | by weight^{a)} | by weight^{b)} | |
| Comparative | 13.6 g, 60 parts | 9.0 g, 40 parts | |
| Example 3 | by weight^{a)} | by weight^{b)} | |
| Comparative | 9.7 g, 43 parts | 12.9 g, 57 parts | |
| Example 4 | by weight^{c)} | by weight^{b)} | |
| Comparative | 9.7 g, 43 parts | 12.9 g, 57 parts | |
| Example 5 | by weight^{a)} | by weight^{d)} | |

^{a)}M1142 (OPPEA) from Miwon Specialty Chemical
^{b)}9,9-Bis[4-(2-acryloyloxyethyloxy)phenyl]fluorene
^{c)}2-hydroxyethyl acrylate
^{d)}Triethylene glycol diacrylate

### Experimental Example: Holographic Recording

The physical properties of Examples and Comparative Examples were measured by the following method, and the results are shown in Table 2 below.

### (1) Recording Method

The holographic recording method was performed using a hologram recording equipment as shown in FIG. 1.

FIG. 1 is a diagram schematically showing a recording equipment setup or hologram recording according to one embodiment. Specifically, FIG. 1 schematically shows the process in which a light source (laser) of a predetermined wavelength is radiated from the laser 10, and irradiated onto the photopolymer (holographic recording medium) 8 located on one surface of a mirror 70 via a mirror-I 2, a mirror-II 3, an object lens 4, a pinhole 5, a collimation lens 6 and an iris 7.

More specifically, when the film containing the prepared photopolymer layer was laminated on a mirror and then irradiated with a laser, a notch filter hologram having periodic refractive index modulation in the thickness direction through interference between incident light L and light reflected from a mirror L′ can be recorded. In this Example, a notch filter hologram is recorded with an incident angle of 0° (degree). A notch filter and a Bragg reflector are optical devices that reflect only light of a specific wavelength, and have a structure in which two layers with different refractive indexes are stacked periodically and repeatedly at a certain thickness.

A holographic recording medium in which a reflective diffraction grating was recorded using a laser was attached to glass and placed in a UV irradiator (Dymax model 2000 flood), UVA was irradiated with an intensity of 105 mW/cm² for about 1 minute, and a photobleaching process was performed to remove the color of the photosensitizing dye and complete the reaction of the photoreactive monomer.

### (2) Ratio (%) of Erosion Layer in Photopolymer Film

The thickness of the erosion layer in the photopolymer film was measured using a scanning electron microscope (SEM, magnification 9000 times), and then the thickness ratio occupied by the erosion layer in the entire photopolymer film was measured according to the following Equation 1-1.

$$Thickness ratio ( \% ) of erosion layer in photopolymer film ( \% ) = Thickness of the erosion layer among the coating layers of the photopolymer film / Total thickness of the coating layer of the photopolymer film \times 100 \qquad [ Equation 1 - 1 ]$$

### (3) Measurement of Diffractive Efficiency (DE) (Unit %) (Recording Efficiency)

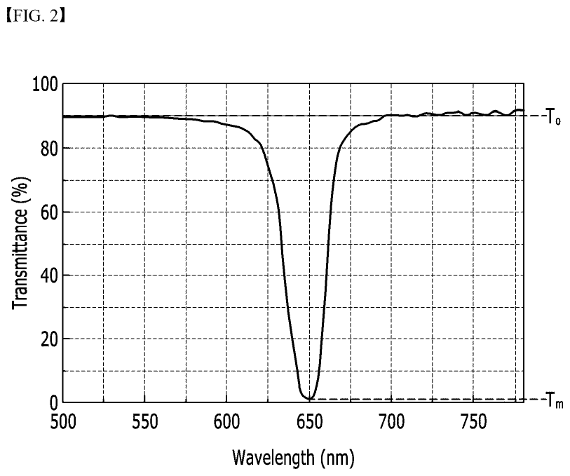

Regarding the holographic recording medium sample using the photopolymer composition, the reflection spectrum of the recorded photopolymer was measured using a UV-VIS spectrophotometer (SolidSpec-3700, manufactured by Shimadzu), the reflection peak was confirmed, and the diffraction efficiency (i.e., recording efficiency) was measured. FIG. 2 is a diagram showing a spectrum for measuring the diffraction efficiency of a holographic recording medium according to one embodiment.

That is, the transmittance was measured in a wavelength range of 500 to 780 nm including the recording wavelength, and the diffraction efficiency was calculated using the following Equation 2.

$$DE ( \% ) = ( T 0 - Tm ) / T 0 \qquad [ Equation 2 ]$$

wherein, in Equation 2,
T₀ is the average transmittance at a recording wavelength in which the recording peak of the holographic recording medium sample of FIG. 2 does not appear,
Tₘ is the minimum transmittance of the photopolymer film at the recording peak of the holographic recording medium sample in FIG. 2.
   (3) Reliability after Recording

For reliability evaluation, the photopolymer film was attached with BPSA and left under heat resistance and moist heat resistance conditions (dark room under constant temperature and humidity conditions of 65° C. and relative humidity of 90RH %) for 72 hours.

Subsequently, the spectrum was measured to confirm the degree of movement of the reflection peak (Δλ), thereby evaluating the heat resistance and moist heat resistance reliability. That is, the reliability was evaluated by a method in which the transmittance according to the wavelength of the holographic recording medium sample was measured using the spectrophotometer, the peak value (λmax) showing the maximum transmittance was measured and then the difference (Δλ) with λₘₐₓ before leaving for 72 hours was calculated.

### (4) Haze

Haze was measured using a HAZE METER (NDH-5000 manufactured by Nippon Denshok) in accordance with JIS K7136: 2000. The measurement light was incident on the substrate side surface of the holographic recording medium.

### (5) Evaluation of Peel Adhesive Force

The holographic recording medium sample was fabricated to have a width of 25 mm and a length of 80 mm, and the sample was attached to the OCA adhesive surface of a 100 mm×100 mm glass plate to which an OCA film was attached. A 180° Peel Test was performed using a Texture Analyzer equipment, the load applied to a width of 25 mm was measured, and the peel adhesive force was evaluated.

### (6) Evaluation of Adhesion

This evaluation was carried out using a cross-cut test, and lines were drawn on the photopolymer film into a checkerboard pattern of 10 squares horizontally and 10 vertically using a blade, and peeled off twice using a tape. Adhesion was evaluated by evaluating the state in which the recording layer was separated from the base surface and grooved or peeled off.

TABLE 2

| | Example | | | | Comparative Example | | | | |
|---|---|---|---|---|---|---|---|---|---|
| | 1 | 2 | 3 | 4 | 1 | 2 | 3 | 4 | 5 |
| Monofunctional monomer (part by | 43 | 46 | 49 | 52 | 0 | 30 | 60 | 43 | 43 |
| weight) | a) | a) | a) | a) | a) | a) | a) | c) | a) |
| Thickness ratio of erosion layer in | 21 | 29 | 41 | 49 | 3 | 8 | 53 | 32 | 27 |
| photopolymer film (%) | | | | | | | | | |
| Diffraction efficiency (%) | 94.2 | 92.1 | 91.6 | 90.8 | 10.5 | 70.8 | 82.6 | 47.3 | 24.2 |
| Heat resistance reliability Δλ(nm) | −7 | −3 | +2 | +6 | −25 | −16 | +18 | −15 | −19 |
| Moist heat resistance reliability | −2 | −1 | +1 | +2 | −23 | −12 | +11 | −13 | −14 |
| Δλ(nm) | | | | | | | | | |
| Haze (%) | 1.4 | 1.2 | 1.2 | 1.0 | 15.2 | 2.1 | 1.0 | 4.3 | 1.6 |
| Peel adhesive force (gf/25 mm) | 1038 | 1283 | 1360 | 1296 | 112 | 693 | 1423 | 981 | 1032 |
| Adhesion | 4B | 4B | 5B | 5B | 2B | 3B | 5B | 4B | 4B |

a) M1142 (OPPEA) from Miwon Specialty Chemical,
c) 2-hydroxyethyl acrylate

Referring to Table 2, it was confirmed that a holographic recording medium (photopolymer coating film) prepared from the photopolymer composition of Examples according to an embodiment of the invention satisfies the ratio of erosion layer in the photopolymer film of 10% or more and 50% or less by adjusting the ratio of monofunctional monomers (low molecular weight acrylate) among recording monomers to a specific range. Thereby, it was confirmed that the recording efficiency (diffraction efficiency) satisfies 90% or more, and the heat resistance and moist heat resistance reliability, haze, peel adhesive force and adhesion are all superior to Comparative Examples.

On the other hand, it was shown that the photopolymer coating film provided by the composition of Comparative Example uses only a difunctional monomer as a recording monomer or contains too little or too much monofunctional monomer, and thus, the diffraction efficiency is relatively low and the heat resistance and moist heat resistance reliability is very poor as compared to Examples. In addition, it was confirmed that Comparative Examples had poor results compared to Examples in terms of haze, peel adhesive force and adhesion.

At this time, as the ratio of monofunctional monomers (low molecular weight acrylates) among recording monomers is larger, the monofunctional monomers more easily invade into the base layer, so that the thickness of the erosion layer of the photopolymer increases. However, if the content is too large, there may be a problem that the recording efficiency decreases and heat resistance and moist heat resistance reliability deteriorate. Therefore, it is important to appropriately adjust the content range of monofunctional monomer in the recording monomer.

That is, in Comparative Example 1, only difunctional monomers were included as recording monomers, so that the recording efficiency was very low, and the overall physical properties of heat resistance and moist heat resistance reliability, haze, peel adhesive force and adhesion were all defective. In addition, it was confirmed that in Comparative Example 2, a monofunctional monomer content was 30 parts by weight, which was lower than that of Examples, and thus, all physical properties were very poor. Further, it can be seen that when the monofunctional monomer is used in an excessive amount of 60 parts by weight as in Comparative Example 3, the recording efficiency and the heat resistance and moist heat resistance reliability decreased.

Even if Comparative Example 4 showed an erosion layer ratio of 10% or more and 50% or less, a monofunctional monomer different from that of the present invention was used, whereby not only the diffraction efficiency was very low as 47.3% but also the overall physical properties such as heat resistance and moist heat resistance reliability and haze were deteriorated as compared to Examples. In Comparative Example 5, the type of monofunctional monomer was the same as that of the present invention, and thus, the erosion layer ratio showed 10% or more and 50% or less. However, due to the use of triethylene glycol diacrylate as a bifunctional monomer, the diffraction efficiency was 24.2%, which was lower than that of Comparative Example 4, and heat resistance and moist heat resistance reliability were defective.

1. A photopolymer composition for forming a holographic recording medium, comprising:
a polymer matrix or a precursor thereof formed by crosslinking a siloxane-based polymer containing a silane functional group and a (meth)acrylic-based polyol; a photoreactive monomer including a monofunctional monomer and a polyfunctional monomer; and a photoinitiator,
wherein the monofunctional monomer is contained in an amount of 42 to 55 parts by weight based on 100 parts by weight of the photoreactive monomer.

2. The photopolymer composition for forming a holographic recording medium according to claim 1, wherein the monofunctional monomer is a monofunctional (meth)acrylate monomer.

3. The photopolymer composition for forming a holographic recording medium according to claim 1, wherein the monofunctional monomer includes at least one monofunctional (meth)acrylate monomer selected from the group consisting of phenoxy benzyl (meth)acrylate, o-phenylphenol ethylene oxide (meth)acrylate, benzyl (meth)acrylate, 2-(phenylthio)ethyl (meth)acrylate and biphenylmethyl (meth)acrylate.

4. The photopolymer composition for forming a holographic recording medium according to claim 1, wherein the siloxane-based polymer is PMHS (polymethylhydrosiloxane), and the (meth)acrylic polyol is a polyalkyl (meth)acrylate having a hydroxy group.

5. The photopolymer composition for forming a holographic recording medium according to claim 1, wherein the siloxane-based polymer includes a repeating unit represented by the following Chemical Formula 1 and a terminal end group represented by the following Chemical Formula 2: 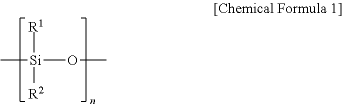
wherein, in the Chemical Formula 1,
a plurality of R¹ and R² are the same or different from each other, and are each independently hydrogen, halogen, or an alkyl group having 1 to 10 carbon atoms, and
n is an integer of 1 to 10,000, 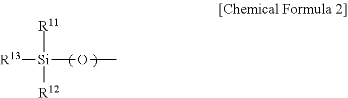
wherein, in the Chemical Formula 2,
a plurality of R¹¹ and R¹³ are the same or different from each other, and are each independently hydrogen, halogen, or an alkyl group having 1 to 10 carbon atoms, and
at least one of R¹, R² and R¹¹ to R¹³ of at least one repeating unit among the repeating units represented by Chemical Formula 1 and any one terminal end group among the terminal end groups represented by Chemical Formula 2 is hydrogen.

6. The photopolymer composition for forming a holographic recording medium according to claim 1, wherein the (meth)acrylic-based polyol has a structure in which a hydroxy group is bonded to a main chain or side chain of a (meth)acrylate-based polymer, and has a weight average molecular weight of 150,000 to 1,000,000.

7. The photopolymer composition for forming a holographic recording medium according to claim 1, wherein the photoreactive monomer includes a photoreactive monomer having a refractive index of at least 1.5.

8. The photopolymer composition for forming a holographic recording medium according to claim 7, wherein the multifunctional monomer includes at least one member selected from the group consisting of bisphenol A modified diacrylate series, fluorene acrylate series, bisphenol fluorene epoxy acrylate series and halogenated epoxy acrylate series compounds.

9. The photopolymer composition for forming a holographic recording medium according to claim 1, wherein the photoreactive monomer is contained in an amount of 70 to 130 parts by weight based on 100 parts by weight of the polymer matrix or the precursor thereof.

10. The photopolymer composition for forming a holographic recording medium according to claim 1, further comprising a fluorinated compound containing a repeating unit represented by the following Chemical Formula 3: 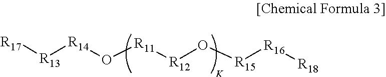
wherein, in the Chemical Formula 3,
R₁₁ and R₁₂ are each independently a difluoromethylene group,
R₁₃ and R₁₆ are each independently a methylene group,
R₁₄ and R₁₅ are each independently a difluoromethylene group,
k is an integer of 1 to 10, and
R₁₇ and R₁₈ are each independently a straight-chain or branched-chain alkyl group having 1 to 10 carbon atoms or a functional group of the following Chemical Formula 4, 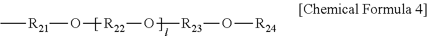
wherein, in the Chemical Formula 4,
R₂₁, R₂₂ and R₂₃ are each independently a straight-chain or branched-chain alkylene group having 1 to 10 carbon atoms,
R₂₄ is a straight-chain or branched-chain alkyl group having 1 to 10 carbon atoms, and
l is an integer of 1 to 30.

11. A photopolymer film comprising a substrate film; and a coating layer including the photopolymer composition of claim 1.

12. The photopolymer film according to claim 11, wherein:
the coating layer includes an erosion layer and a recording layer, and
a thickness ratio of the erosion layer to the coating layer satisfies the following Equation 1:
$$10 \% \leq Thickness of the erosion layer among the coating layer of the photopolymer folm / Total thickness of the coating layer of the phototpolymer film \times 100 \leq 50 \% . \qquad [ Equation 1 ]$$

13. A holographic recording medium comprising the photopolymer film of claim 11.

14. An optical element comprising the holographic recording medium of claim 13.

15. A holographic recording method comprising selectively polymerizing the monofunctional monomer and the polyfunctional monomer contained in the photopolymer composition of claim 1 using a coherent laser.
